(19) United States
(12) Patent Application Publication
(10) Pub. No.: US 2026/0000920 A1
(43) Pub. Date: Jan. 1, 2026

(54) Personal Protective Garment Cooling System for Harsh Environments

(71) Applicant: University of Cincinnati, Cincinnati, OH (US)

(72) Inventors: Myoungok Kim, Loveland, OH (US); Ashley Kubley, Cincinnati, OH (US); Vesselin Shanov, Cincinnati, OH (US); Mark Schulz, West Chester, OH (US); Qichen Fang, Cincinnati, OH (US); Ione Wu, Cincinnati, OH (US); Christopher Kenneth Cooley, Cincinnati, OH (US); Prakash Giri, Cincinnati, OH (US); Vamsi Krishna Reddy Kondapalli, Hillsboro, OR (US); Manjeera Vinnakota, Mason, OH (US); Kathryn Ann York, New Carlisle, OH (US); Calvin Brant, Dayton, OH (US)

(73) Assignee: University of Cincinnati, Cincinnati, OH (US)

(21) Appl. No.: 19/255,289

(22) Filed: Jun. 30, 2025

Related U.S. Application Data
(60) Provisional application No. 63/665,735, filed on Jun. 28, 2024.

(51) Int. Cl. A62B 17/00; B32B 5/02; B32B 5/06; B32B 5/26; B32B 9/00; B32B 9/04

(52) U.S. Cl. CPC A62B 17/003; A62B 17/005; A62B 17/006; B32B 5/022; B32B 5/073; B32B 5/265; B32B 9/007; B32B 9/047; B32B 2255/26; B32B 2571/00

(57) ABSTRACT

A wearable garment that is capable of providing protection from heat is provided. The garment includes a fabric layer with a carbon nanotube (CNT) sheet. In one embodiment, the fabric layer further includes a layer of meta-aramid material. In another embodiment, the CNT sheet is integrated with a meta-aramid material by stitching the CNT sheet and meta-aramid material together, where the meta-aramid material is Nomex fabric.

### CROSS-REFERENCE TO RELATED APPLICATIONS

This application claims priority to, and the benefit of the filing date of, U.S. Provisional Application No. 63/665,735 filed Jun. 28, 2024, the disclosure of which is incorporated by reference herein in its entirety.

### FIELD OF THE INVENTION

This invention relates generally to protective garments.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Firefighters experience significant hazards on the job. Common fireground injuries include overexertion and slips/trips, and falls, as well as exposure-related injury: specifically, exposure to heat, toxic chemicals, viruses, carcinogens, etc. during service, which can lead to injury. Specifically, increased physical demands, temperature stress, and exposure are exacerbated by the gear that firefighters are required to wear. Protective clothing is essential for firefighters to protect against thermal exposures and other life-threatening risks. Many heat-related injuries are caused by environmental stress and metabolic heat and are quite common. Heat stress, or hyperthermia, is dangerous, and has both short- and long-term health consequences since the combination of hot ambient temperatures and intense physical work leads to increases in core body temperature, which results in heat related injuries. This indicates a critical need for a preventative solution to reduce firefighter injuries and hence the financial burden resulting from treatment and after-care of these injuries.

Despite the importance of firefighters' heat related injuries, there have been very few cooling system devices available to reduce the metabolic core body temperature (CBT) of firefighters while they are firefighting on the job. Several commercial products are available for non-firefighter related use because all materials used in Personal Protective Equipment (PPE) for the fire service are required to meet the National Fire Protection Agency (NFPA) 1971 standards, which limits the range of study in materials and designs.

These products in the marketplace consist of two categories of cooling devices: 1) passive (evaporative, phase change, and cold pack cooling) vests that generally featured removable cooling packs, and 2) active cooling vests (liquid, and air-cooling vests with electronic components) with a cooling source that circulates cooled water or air to the body core. Essentially, the difference between active and passive vests is that passive vests do not require a power source, do not require any moving (mechanical) parts, but have a short usage time. In this sense, the materials themselves do the work, but may be innocuous during extremely hot environmental conditions such as firefighting and are intended to be worn in recovery. The passive removable cooling devices require the cooling pack to be frozen in ice water or in the refrigerator before being inserted into the laminated pocket of the vest. However, this type of cooling system has the disadvantage that the cooling pack needs to be activated in advance to achieve the cooling effect and does not last long in hot environments. This type of cooling apparatus is the most affordable, and thus more widely adaptable.

Active vests that use pumps or airflow require batteries, wirings, and mechanical parts that need to be activated. Due to the difficulty in passing integrated mechanical devices embedded in garments through the NFPA standards, none have been designed as integrated features to be placed in fire service gear. Furthermore, both active and passive cooling solutions must be donned close to the body (e.g. under the turnout garment or with the garment off) and may be applied only after the heat stress event has occurred as a remedial solution instead of a preventative one, therefore taking the user out of active duty by requiring the removal of their turnout gear to use these cooling solutions during their recovery period. The active cooling systems, a vest that includes a portable cooling device, is more intelligent in use, since they do not need to be activated in advance, and the user can control the temperature of the vest to achieve constant cooling effects. However, they are more expensive and are usually heavier and more cumbersome because they require users to carry additional cooling equipment or be in a static, stationary position (e.g. connected with tubing to a cooler filled with water, for instance) to ensure that the vest remains in the cooling state.

The NFPA 1971 is the Standard on Protective Ensembles for Structural Firefighting and Proximity to Firefighting. It protects firefighting personnel by establishing a minimum level of protection from thermal, physical, environmental, and bloodborne pathogen hazards encountered during the proximity of firefighting operations (NFPA 1971, 2018). NFPA-certified turnout gear consists of three layers of materials, which is made up of an outer shell, a moisture barrier, and a thermal liner. This multi-layered material used in firefighter gear protects skin from heat and flame damage. All firefighter turnout coats require these protective layers: the lining layer protects the user's body from heat, the moisture barrier prevents liquids and/or waterborne contaminants from contacting the skin, and a tough outer shell that provides fire-resistance and burn protection from flame flashover and ignition of the PPE materials. Each of these layers is subject to specialized and intensive protective testing listed in the NFPA standard, which for garments is NFPA1971.

Current firefighter PPE does not provide enough system devices to reduce the metabolic core body temperature (CBT) of firefighters while they are firefighting on the job. Therefore, a need still exists for improved firefighter PPE gear.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention.

In an embodiment of the invention, a wearable garment is provided. The wearable garment is capable of providing protection from heat and the garment includes a fabric layer with a carbon nanotube (CNT) sheet. In one embodiment, the fabric layer further includes a layer of meta-aramid material. In another embodiment, the CNT sheet is integrated with a meta-aramid material by stitching the CNT sheet and meta-aramid material together, where the meta-aramid material is Nomex fabric. In one embodiment, the fabric layer further comprises a layer of woven thermal facecloth fabric.

In another embodiment, the carbon nanotube sheet is produced using a floating catalyst Chemical Vapor Deposition (CVD) method. In one embodiment, the carbon nanotube sheet is made by dry drawing of CNT arrays produced by a CVD method. In another embodiment, the carbon nanotube sheet comprises Bucky Paper produced by dispersing carbon nanotubes in solution followed by their filtration.

In one embodiment, the carbon nanotube sheet is coated with a protective polymer film for enabling case of handling and reduced shedding during washing. In another embodiment, the carbon nanotube sheet is coated with a polyureasilazane material. In one embodiment, the garment also includes a core guard, where the core guard is attached as an additional and detachable panel that is mounted to the garment to accommodate and hold a cooling apparatus for a user.

In another embodiment, a gap is created in the core guard that allows forced cool air flow through the garment. In one embodiment, air circulates internally between the garment and a user's undergarment and air circulation is driven by two incorporated cooling devices. In another embodiment, the core guard has a design that supports internal cooling and is located at an elevated level within the garment thus preventing air from being sucked from the outside environment and penetrating the garment.

In one embodiment, the garment is configured so air is supplied from the outside environment drawn by a cooling device and circulates between the garment and a user's undergarment, then leaving the garment through any openings, including sleeves, collar, and lower portion of the garment. In another embodiment, the core guard has a design that supports external cooling and is located at a lower level within the garment thus enabling air to be sucked from the outside environment and penetrating the garment.

In one embodiment, a fabric-made pouch is sewn onto the core guard. In another embodiment, the pouch has a mesh at its bottom part allowing air to be drawn in a cooling device. In one embodiment, the pouch accommodates a coolant material selected from the group consisting of dry ice, water-based ice, and other packed coolants. In another embodiment, the garment also includes a water repelling ISO Dry Knit to protect electric wire connections from water and sweat. In one embodiment, the garment includes a cooling unit made from fire resistant materials that pass the standard tests for National Fire Protection Agency compliance.

### BRIEF DESCRIPTION OF THE DRAWINGS

The objects and advantages of the disclosed invention will be further appreciated in light of the following detailed descriptions and drawings in which:

FIG. 1 is a schematic of an embodiment of the cooling garment of the present invention and its components.

FIG. 2A is an image of an Emergency First Responder Rehabilitation Cooling Unit (n.d.).

FIG. 2B is an image of a TEM-based mini-cooling unit.

FIG. 2C is an image of a fan-based cooling vest.

FIG. 2D is an image of a PCM-based cooling vest.

FIG. 2E is an image of a water-vapor absorption composite film.

FIG. 2F is an image of a water evaporative cooling vest.

FIG. 2G is an image of a water circulating cooling vest.

FIG. 3 is a schematic showing fabric layers.

FIG. 4 is a schematic of an embodiment of the interior of cooling garment of the present invention with a liner.

FIG. 5A is a schematic of a core guard according to the present invention.

FIG. 5B is a schematic of a core guard with a first alternative pouch orientation.

FIG. 5C is a schematic of a core guard with a second alternative pouch orientation.

FIG. 6A is a schematic of a cooling apparatus with a housing.

FIG. 6B is a schematic of an ISO dry knit cover.

FIG. 6C is a schematic of a filter.

FIG. 6D is a schematic of a pouch.

FIG. 7A is a schematic of one side of an external cooling system with the cooling apparatus between the garment liner and core guard.

FIG. 7B is a schematic of the other side of the external cooling system of FIG. 7A.

FIG. 8 is a schematic of an internal cooling system.

FIG. 9 is a graph showing fabric thickness results.

FIG. 10 a schematic showing a typical vertical filtration setup

FIG. 11 is an image showing inline filter holders and CNT-ceraset samples.

FIG. 12 is an image showing setup preparation. One CNT-ceraset membrane was placed in the inline filter holder.

FIG. 13A is an image showing setup placement.

FIG. 13B is an image showing the back surface of the sample after water test.

FIG. 13C is an image showing the back surface of the sample after naphthalene test.

FIG. 14A is an image showing the hydrophobic nature of CNT sheet. It is typical for CNT based materials such as CNT-ceraset.

FIG. 14B is an image showing the oleophilic nature of CNT sheet.

FIG. 15 is a series of images showing infrared images results, front and back, outside and inside for an external cooling device.

FIG. 16 is a series of images showing infrared images results, front and back, outside and inside for an internal cooling device.

FIG. 17 is an image showing locations of sensor 1, sensor 2, and sensor 3 inside the firefighter coat.

FIG. 18 is a graph showing live burn testing results.

### DEFINITIONS

As used herein, the term “about,” when referring to a value or to an amount of mass, weight, time, volume, pH, size, concentration or percentage is meant to encompass variations of +20% in some embodiments, +10% in some embodiments, +5% in some embodiments, +1% in some embodiments, +0.5% in some embodiments, and +0.1% in some embodiments from the specified amount, as such variations are appropriate to perform the disclosed method.

As used herein, “Bucky Paper” means a flexible sheet made from carbon nanotubes. The carbon nanotubes may be single-walled or multi-walled.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present invention involves a personal protective garment cooling system for harsh environments. This cooling system is a new development in cooling technology that could be useful for all industries or applications where exposure to heat and environmental contaminants are issues. The present invention offers active, consistent and compact cooling, a strong and lightweight fabric, and a protective barrier all in one. The cooling garment disclosed herein has been integrated into an existing firefighter turnout garment as a new thermal lining system but could be adapted to many different industrial applications. The cooling device and fabric system work in tandem as a system.

In various embodiments, the present invention involves a) the development of novel material composition designed especially for firefighter turnout gear in this case, but applicable to other types of Personal Protective Equipment (PPE) for occupational and health and safety, athletic and leisure garments that are subject to use in hot environments or are needed to shield the body from environmental contaminants, b) an integrated cooling device designed to reduce heat related injuries and minimize hyperthermia when users encounter extremely hot environments especially for long periods of time, and C) a shielding material that protects the user from harmful materials and stifling air entering the garment and contacting the body/skin. The system meets all required National Fire Protection Agency (NFPA) standards, which is a necessary qualifier for PPE used by the US fire service. This invention is used as PPE in this case.

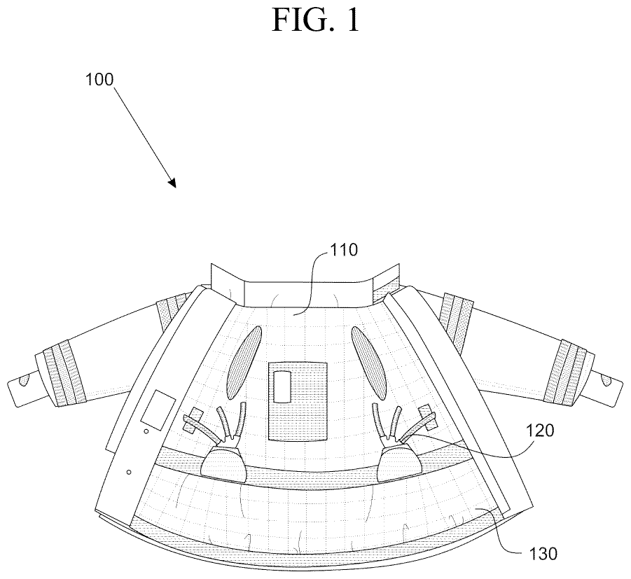

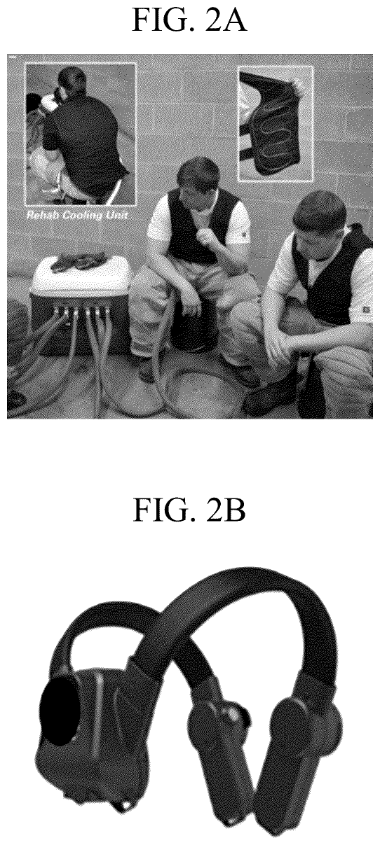

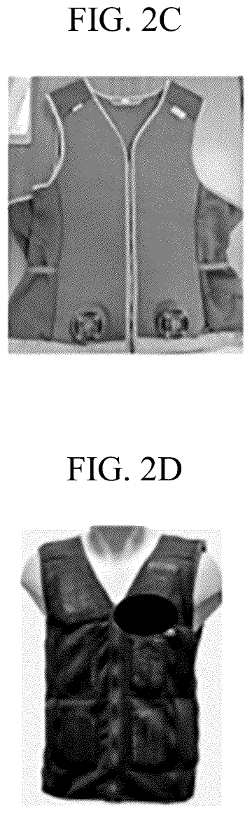

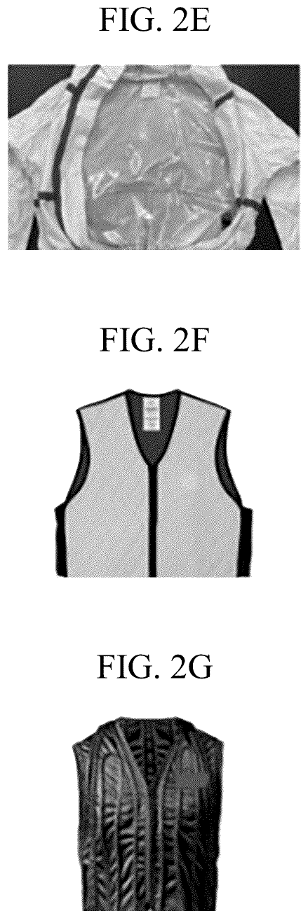

In one embodiment, the cooling garment system of the present invention comprises three parts that work in tandem within the lining layer of the PPE (FIG. 1). The cooling garment 100 includes a cooling garment liner 110, a cooling apparatus 120 and a core guard 130. The synthesis of these aspects forms the foundation of the new protective system.

### Garment Liner

One embodiment of the present invention involves a protective thermal garment lining quilt that includes a new fabric composite made with Carbon Nanotube (CNT) sheet materials. The addition of the CNT material blocks harmful materials from entering the garment, adds a level of thermal protection that allows one of the (originally 2) layers of nonwoven thermal fabric to be removed from the lining quilt, and helps to spread cooled air rapidly throughout the garment liner in the planar direction, thereby enhancing the distribution of cooling. This novel fabric also makes the garment lighter, thinner and more flexible than what is currently available/used as the standard in the fire service today, while still maintaining protective standards set by the NFPA1971: Standard on Protective Ensembles for Structural Fire Fighting and Proximity Fire Fighting (NFPA 13). The new fabric increases garment comfort and dexterity for the user and reduces overall weight of the fabrics.

### Cooling Apparatus

The cooling apparatus is a compact active cooling apparatus. One or more units can be attached to the inside of the garment lining and be worn under the turnout gear. In this way, the user can benefit from cooling during active service.

### Core Guard

A waist-level gaiter with an elastic band prevents outside air from entering the interior of the garment along the hemline edge-referred to hence forth as the “core guard”. The core guard is derived from U.S. Pat. No. 8,522,368B2, which is described as a vapor skirt sewn onto the coat to protect from harmful vapors and other undesired materials. In this invention, the core guard serves as an assembly to hold all cooling housing components and pouches in specially designed pockets. It also serves as a barrier to prevent external, contaminated air from entering the garment from the gap between the body and the garment at the hemline edge of the garment and blocking hot air from entering a hot environment. The core guard is made of CNT fabric lining quilt the same as the fabric lining described above and is detachable with hook and loop tape (AKA Velcro). The core guard is mounted to the inside of garment for easy removal. Depending on the forced air source, there are two types of core guard assemblies: external and internal, which are described in detail herein.

### Garment Cooling System

The present invention includes a novel garment liner using an innovative CNT composition that incorporates cooling features to mitigate heat-related injuries and shielding features for use during firefighters' duty. The firefighters' active cooling garment utilizes the existing turnout gear garment design, which is already adopted by the fire service. Various adjustments have been implemented to enhance fabric performance, including the incorporation of a mechanical internal cooling system, distinguishing the present invention from traditional turnout gear designs.

### Materials

One aspect of this garment design that is unique is the heat resistance of the entire system. The fabrics and all materials included in this system are subject to thermal testing and heat resistance testing to comply with the standards of the NFPA for protection. This includes the fabric makeup of the coat and the materials that the housing protects and organizing the cooling unit components. The main test used to determine this is the no-melt no burn test, NFPA 2112: Standard on Flame-Resistant Clothing for Protection of Industrial Personnel Against Short-Duration Thermal Exposures from Fire. The materials used in both the fabric and the cooling unit pass these standards.

### Carbon Nanotube Sheet

The invention includes a revised thermal lining fabric with carbon nanotube (CNT) sheet materials integrated. The material intervention in this case is the introduction of the CNT material into the traditional thermal lining composite as an alternative performance material to the existing fabric components used in the current system. The CNT material can be combined with a meta-aramid material such as Nomex. In one embodiment, a Nomex/Kevlar nonwoven web is used. A woven fabric layer can also be used. In one embodiment, the three layers are quilted together to form the planar fabric material used to construct the innermost thermal liner of the turnout garment. The CNT sheet is inserted between a single layer of nonwoven thermal fabric and a woven thermal facecloth fabric. The CNT can be treated with silicone, furthermore, referred to as the “Ceraset CNT” sheet. In one embodiment, the silicone used for treating the CNT is polyureasilazane. This sheet is sandwiched between a single layer of thermal batting. During manufacturing, the CNT sheets may be treated with silicone, which further enhances heat resistance and reduces shedding of CNT particles during washing and handling.

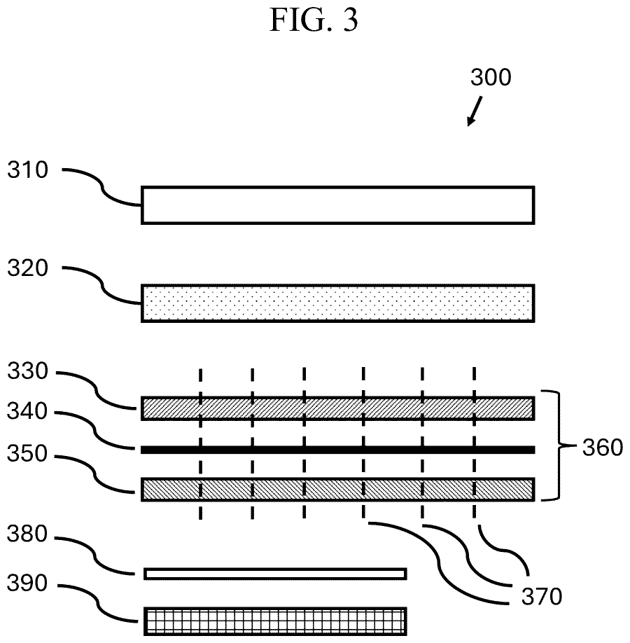

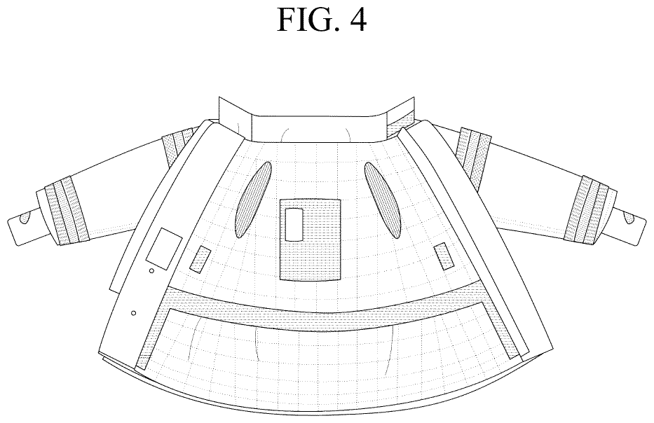

FIG. 3 shows a layering system for a Firefighter PPE Coat system including the thermal lining with Carbon Nanotube Sheet material included. A cross-sectional view 300 of an embodiment of the coat fabric system is shown in FIG. 3. The system includes an outer shell 310, a moisture barrier 320, a Nomex thermal barrier 330, a thin layer of CNT ceraset sheet 340, and a face cloth 350. These three layers become one thermal liner 360 by quilting together using thread 370. In one embodiment, the silicone treated CNT sheet 340 is sandwiched between a single layer of the thermal batting 330 made from the E89 web and a single layer of the GLIDE facecloth 350. In this embodiment, the three layers are industrially quilted through using a two inch grid stitching pattern with NOMEX fire resistant thread. FIG. 3 further shows shirt fabric 380 and the firefighter's skin 390. In one embodiment, the shirt fabric is Tyndale FR wicking base layer shirt fabric.

The CNT sheet 340 is inserted between the thermal barrier 330 and face cloth 350, and it also acts as a barrier to harmful gas permeation. The CNT sheet 340 improves thermal insulation and heat-spreading. The composite material is used for the entire garment liner, the core guard, and housing pouch. The composite material layup is further described in Table 2.

### CNT Fabric System for Turnout Coat Thermal Lining

All firefighter turnout garments require several protective layers; 1) an inner thermal barrier liner that protects the user's body from heat, 2) a moisture barrier which prevents water and other liquid or waterborne contaminants from entering the garment and contacting the skin, and lastly 3) a tough outer shell that provides fire-resistance from flame flashover and burning. The outer shell and moisture barrier materials are unchanged from the Lion EXPRESS (n.d.) version standard coats that LION produces. The moisture barrier and outer shell layers of the turnout garment were not modified, only the composition of the innermost lining layer was modified for the disclosed invention.

In one embodiment, the thermal liner is made from E89 web, a silicone treated CNT sheet and a single layer of the Glide face cloth made by Safety Components. The three layers are industrially quilted. Using a 2-inch grid stitching pattern with Nomex fire resistant thread (see FIG. 3). The inclusion of these aspects enabled the removal of one of the bulky thermal layers, replacing it with the CNT layer. This reduces the overall thickness and increases thermal protective performance, strength, and adds a shielding material that can also help spread heat and moisture across the surface of the fabric.

The material works in tandem with the cooling system to provide a “capsule” of cool air that can circulate and spread within the interior of the coat. The CNT material also provides protection for the cooling system components such as the battery and electronics from failure. The CNT material also provides electromagnetic shielding capabilities.

Heat Resistant Filament used for Cooling Unit Housing

Because an embodiment of this device may include electronic components, a heat-resistant housing was designed that could protect these elements from heat damage and prevent injury to the user, therefore a heat-resistant material was required to fabricate the housing unit that protects and organizes the components in a compact, efficient and safe manner. In one embodiment, carbon-reinforced polyether ether ketone (CF PEEK) is used as a material since it can be used in rapid prototyping manufacturing (3D printing) and passes the tests outlined in heat related standards for materials in the turnout gear. The material can both withstand a long duration of high heat as well as self-extinguish a direct flame once removed.

### Cooling Apparatus Design

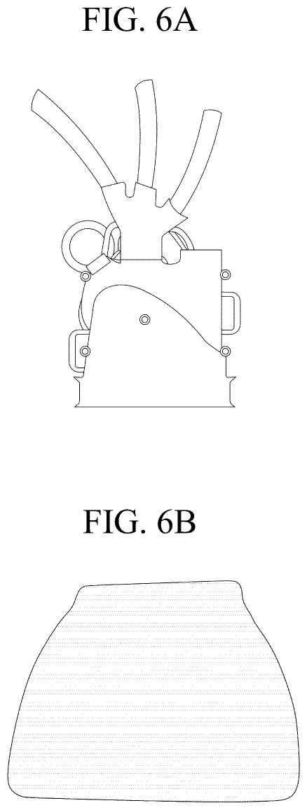

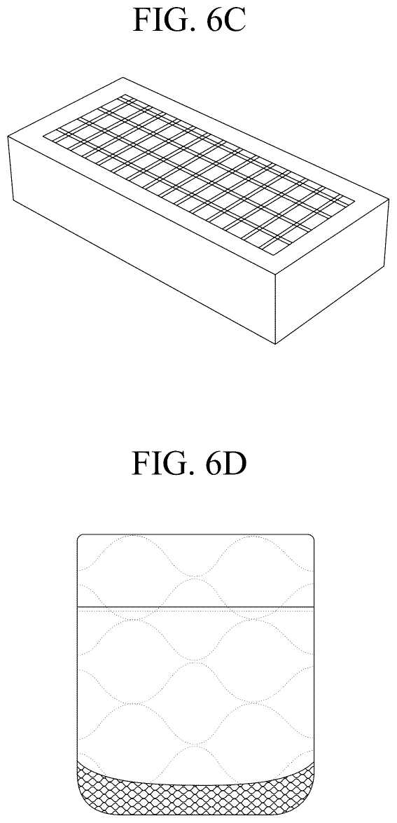

The active cooling apparatus incorporates the following components (FIGS. 6A-6D). A cooling housing (FIG. 6A), a vented pouch (FIG. 6D) to hold cool material, a filter (FIG. 6C) to remove harmful gas and airborne particulate, and a housing (FIG. 6A) to hold all components together and direct flow efficiently into the inside of the garment. In some embodiments, the cooling apparatus includes an ISO dry knit cover (FIG. 6B). In one embodiment, this cover is constructed from Kevlar material, which not only conforms to fire compliance standards but also possesses water-repelling properties. Its stretchable knit feature ensures a seamless covering of the cooling housing components. In one embodiment, the pouch is located at the bottom of the assembly and is made from Carbon Nanotube (CNT) composite material surrounding pouch body and Kevlar mesh at the pouch bottom. The Kevlar mesh bottom allows environmental air to be pulled in. The pouch also has a flap (secured by hook-and-loop strips) to allow the cooling material to be placed inside the cavity. Sewn onto the core guard, the pouch holding the coolants is integral to the system. Positioned inside the pouch at the bottom is a filter, which is HEPA-rated and fire-resistant. Composed of glass fiber media and aluminum sheet, the filter ensures effective filtration within the assembly.

### CNT Garment Lining

The garment lining (FIG. 4) is crafted from the advanced materials detailed earlier, enhancing the rapid dispersion of cooled air while effectively blocking polluted air. By incorporating this innovative material layup, the invented liner complies with the NFPA 1971 standard. Furthermore, it leverages the existing turnout gear coat lining (Lion Express, n.d.) that already meets the requisite standards. The sole alteration involves the addition of Velcro tape and strap fasteners to secure the core guard and cooling apparatus in place. A broad Velcro tape encircling the waist level allows for the adjustment of the core guard's height. These fasteners are designed to secure the tubing that delivers cooled air from the housing to the wearers' chests and backs, ensuring optimal positioning and functionality.

### Core Guard

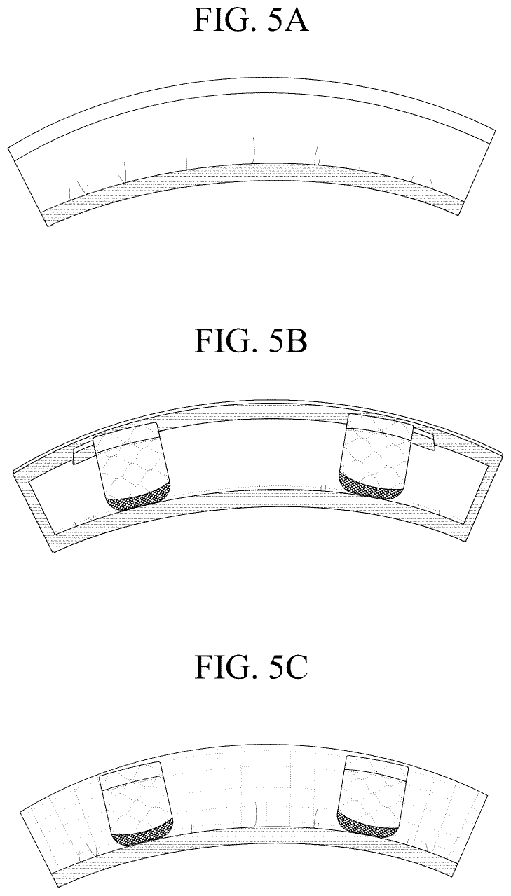

The core guard serves a triple purpose: it not only shields against harmful substances but also houses the cooling apparatus, effectively maintaining cooled air while blocking hot external air from entering. Additionally, it features a detachable option, allowing for the removal of the cooling apparatus for normal duty situations. The core guard (FIGS. 5A-5C) is an additional panel that attaches to the inside of the garment using Velcro tape (or hook-and-loop strips). Velcro tape is sewn onto the liner bodice to facilitate easy detachment of the entire cooling assembly. The loop strip is sewn on the inside of the garment (or liner of garment) and the hook strip is sewn onto the core guard. The bottom of the core guard fits to the body contour with elastic band, and it blocks toxic air (or polluted) and keeps the filtered cooled air inside of the garment. The core guard provides active cooling to the garment by holding a cooling housing when firefighters need to cool down their body temperature. The core guard is to hold all cooling components, to block the harmful air, and to provide filtered clean air to the firefighters' body skin.

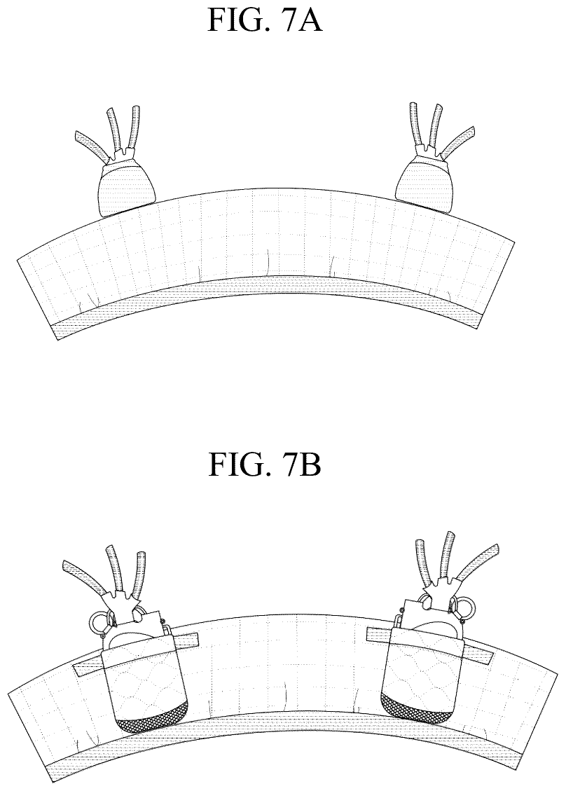

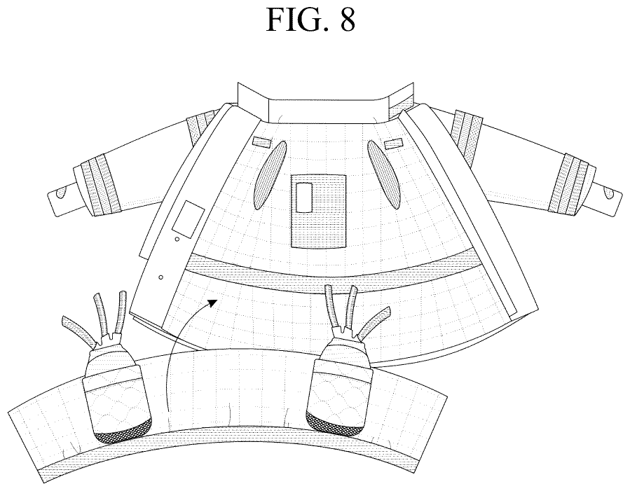

The core guard has two types depending on the forced air source: external versus internal one. The external one has pouches onto the outside that faces external while the internal core guard has the pouches onto the side faces internal FF's body. The active cooling apparatus is placed between the garment (shell or liner) and the core guard, and the cooled air is provided through the duck of the housing. Depending on the forced air source, there are two types of core guard assembly: external vs internal. The external one will have the cooling apparatus between the garment liner and core guard. The core guard blocks polluted and hot air, while a filter inside the cooling apparatus delivers clean and cooled air to firefighters' bodies (see FIGS. 7A and 7B). On the other hand, the internal one (FIG. 8) has the cooling apparatus between the core guard and FFs' station wear/wicking shirt and the core guard will block polluted air. The internal cooling device recirculates the internal air that is filtered inside of the core guard.

The combination of these innovations results in a more protective set of firefighter turnout gear. The current gear balances heat protection and breathability and is limited by the need to allow heat transfer away from the firefighter to prevent internal overheating. By implementing a garment cooling system to cool the inside of the garment, the material could then use cutting edge CNT sheet to maximize the thermal insulation of the garment and greatly increase the protective performance from hyperthermia utilizing cooling apparatus which provides powerful active cooling resource.

However, such a garment that maximizes thermal protection will limit breathability as previously mentioned. This is not a concern when a cooling system is activated but means that the garment would always need to have the cooling system on, and also that the garment would not pass important portions of the standards controlling the performance of the turnout gear. Therefore, the protective performance of the new composite layup was tuned so that it would match the current thermal performance of the regular material. This means that the new material is lighter and more ergonomic, while still performing similarly to the current material. The CNT also provides the added benefit of shielding harmful gas from permeating as casily through the composite. Additionally, the inside of the garment is actively cooled by the cooling apparatus. This way, the new material garment also passes all standards, and is completely functional without having the cooling apparatus switched on.

### Features and Benefits

Features and benefits of the present invention include:

The integrated cooling system in the garment cools the interior space of the garment, thereby reducing heat related stress and increasing the performance of the user.

The integrated cooling system includes a novel fabric composite that introduces Carbon Nanotube Hybrid (CNT) sheet materials that have never been used before in clothing. The addition of CNT hybrid materials allows the lining material to have:
A. enhanced cooling through increased thermal spreading properties of CNT
B. Enhanced moisture wicking through the increased moisture spreading properties of CNT
C. Added filtration and barrier from external contaminants as CNT is impermeable
D. Enhanced thermal protection as CNT is thin, lightweight but offers comparable protection to Kevlar+Nomex
E. Added strength compared to Kevlar+Nomex fabrics

The new fabric composite adds a level of thermal protection that allows one of the two layers of nonwoven thermal fabric originally used in the firefighter turnout garment liner composite to be removed from the fabric layup without compromising the standard level of thermal protection. Due to the inclusion of the CNT material, a thinner, more protective version of the liner fabric can replace an older, more cumbersome material made from additional layers of Kevlar+Nomex, making the garment feel thinner, more malleable/flexible and in turn, more comfortable for the user.

The integrated cooling unit allows forced air to flow/circulate inside the garment. CNT fabric helps spread cooled air rapidly across the fabric in the planar direction, thereby enhancing the distribution of cooling to the extremities. These aspects together accelerate moisture wicking and evaporation.

The integrated cooling system can be worn as part of the garment system, not as a separate device. This means that the device can work actively while the user is performing tasks, and even pre-cool the body. There is no need to doff (take off) the garment, as is the case in other cooling vest solutions—The invention can safely be worn while working.

The integrated cooling unit is compact, portable and efficient. The level of cooling provided by the cooling system is much better than traditional solutions that use bulky, heavy ice packs and water coolers with uncomfortable tubing.

Integrated cooling garment intensifies the benefit of a core-guard to block harmful air and deliver filtered cooled air to internal garment environment.

The integrated cooling garment can be easily activated or deactivated with an electronic switch or a remote switch from up to 50 meters. A fuse embedded in-line with the wiring is also added as a safety feature.

Integrated cooling garment assembly can be easily installed inside the garment using hook and loop tape (Velcro) for easy removal laundering or non-heat-intensive jobs.

The integrated cooling garment has an air filter to remove contaminants before passing into the garment's interior.

The integrated cooling unit and the fabric are made from materials that are fire resistant and pass the standard tests for NFPA compliance, a first of its kind.

The carbon-based material in the cooling garment spreads external heat thus reducing the amount of heat penetrating the garment at an external hot spot. Also, the carbon-based material acts as a Faraday shield thus preventing electromagnetic fields and electrical discharges from entering the garment and the body.

The garment can be used as a protective garment for other first responders beside firefighters, exposed to hot and hazardous environments. Also, the garment can be used as a coat for recreation and sport in a hot environment.

The CNT fabric is impermeable to air, preventing gas permeation through the garment, and can shield garments from airborne toxic chemicals and smoke particles in the air. Also, the CNT fabric, is impermeable to water and can shield garments from fluids and toxic chemicals. In one embodiment, pristine and hybrid CNT fabric is disclosed, where the fabric can be used for shielding in different configurations for shielding.

Additionally, the wearable garment is effective for any soft goods applications that require cooling. The wearable garment is also effective for any garment that requires shielding from harmful radiation or chemicals. Further, the wearable garment protects against harsh environments, heat and elevated temperatures. The wearable garment can protect against harmful radiation or toxic exposure including gasses particles and liquids.

In one embodiment, the present invention is a hybrid fabric comprising one or more materials selected from the group consisting of CNT, metallic nanoparticles, silicones, Kevlar, fiberglass and carbon fiber.

### Uses and Applications

Embodiments of the present invention include a final coat fabric system that is a layered fabric design intended for firefighter PPE but may also be useful in other applications. These applications include, but are not limited to: Bomb Deactivation Suits, Underwater Welding, Biohazard/HazMat Suits, Teflon replacement material, Ballistic Garments/Soft Goods, Aerospace applications, Foodservice applications, and Leisure and athletic applications.

Furthermore, the possible product applications are many. In this case study, the fabric system was used for a top garment (coat lining), but the materials are not limited to apparel applications; other soft goods items such as gloves, footwear, headgear, packs, pouches, reinforcement materials, etc. could also have potential for use of the material's many properties. As listed above, this touches many different industries and applications where users are exposed to high temperatures and hazardous materials.

The present invention discloses the synthesis of new breakthrough materials and cooling devices that allow for the next generation of firefighter turnout gear to be lighter, more ergonomic, more protective, and less stressful for the firefighter to wear. It has the ability to be tuned to the situation at hand, with an air conditioning system that can be activated with the push of a button. The mechanical components are each easily removable and the new composite is able to be regularly laundered. In one embodiment, an outside device is used to freeze the cooling material, which could be be located at the station or implemented on the truck (or even to be taken in a mobile cooler onto the truck). Overall, the next generation turnout garment disclosed herein allows firefighters to focus on the task at hand and perform optimally and safely.

### EXAMPLES

Overall, through design, testing, and user feedback, a working prototype was developed that excels in physical performance, cooling, and shielding capabilities, distinguishing it from current market offerings. Testing proved that the Carbon Nanotube material improves the physical properties of existing liner fabrics used in current turnout garments, including reduced thickness, shrinkage resistance, thermal protection, electromagnetic and particle shielding, and heat spreading.

It was also found that the material layering system currently used can be reduced in thickness by 48% by replacing a thermal layer with the CNT layer, and Firefighters found that this made the garment more comfortable to wear. The materials were evaluated in screening testing and initially deemed compliant to the required NFPA 1971 Standard, thereby indicating that the material is safe for use in turnout gear and comparable in terms of performance to the materials used in current turnout gear. Testing in an independent lab is needed to certify that the new material meets NFPA standards. Furthermore, the intervention introduces wearable electronics that have also been evaluated for fire and heat resistance, which has not been done before.

### Example 1—NFPA 1971 Standard Fabric Testing

Standard lab experiments were conducted to test the fabric properties, particularly those tests required to meet the National Fire Protection Agency (NFPA) standards, which are a minimum requirement of materials. The testing was performed at the LION laboratories in Dayton, Ohio where they perform survey tests in their laboratory to determine if a fabric is suitable to meet NFPA standards (NFPA1971) for fire service garment materials. The lab is used as a screening method for new technology. The grain direction, layering order, thickness, strength and flexion as well different compositing methods (stitching, adhesive, thermal welding) to determine the optimal design. Ten separate fabric tests are performed to meet the NFPA1971 Standard on Protective Ensembles for Structural Fire Fighting and Proximity Fire Fighting (CITE). Eight of these ten tests require testing of the coat lining material that was modified for this project.

Three different versions of the fabric assembly were tested to reach a compliant result. Many iterative experiments with different fabric combinations were used at each stage to reach the optimal result while keeping compliance with the standard. Table 1 shows the material layers at each stage of testing. Table 1 shows the results from the 3 rounds of fabric testing performed to meet NFPA1971 standard compliance and shows a comparison between the different versions of the fabric compositions used in the linings of the coat.

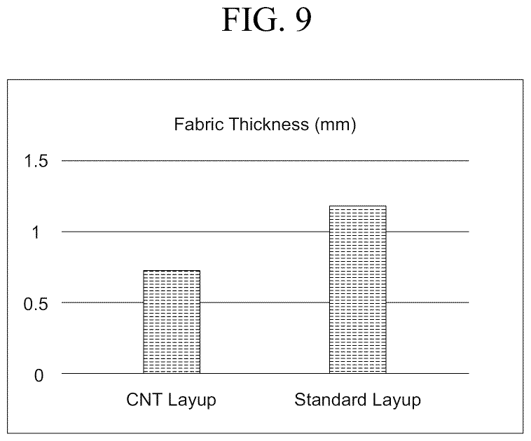

The coat lining system that includes the novel CNT layer of the present invention provides light weight and ease of movement. The thickness of the new fabric was 0.74 mm, while the Lion Standard was 1.21 mm, FIG. 9. That is 48% reduction in thickness overall without compromising performance. Seam strength is at least three times better with the CNT lining fabric.

The thermal protective performance (TPP) test is a test of the heat insulation properties of the fabric where external heat should be prevented from passing through the fabric. The total heat loss (THL) test is the opposite. It deals with removing metabolic heat, so heat must pass through the fabric, and we want moisture to pass through the fabric because evaporation removes heat. Therefore, the two tests (TPP and THL) are counter to each other. If TPP increases, generally the THL will decrease, and vice versa. So, there is a trade-off. Fabrics must meet both the TPP and the THL requirement. TPP is blocks external heat. THL is dissipating internal metabolic heat through the garment. Higher TPP numbers do not necessarily equate to better overall protection for the firefighter (FF). The TPP test is not accurate for any measurement above 60. A high TPP value can be obtained using a heavy, bulky garment. The heavy garment would restrict mobility and increase heat stress. For these reasons, the literature shows that most garment materials are designed in the upper 30 to lower 40 TPP range. The TPP test is run on a flat surface, in a static environment, with a constant heat source. These conditions are not exactly representative of conditions that could exist in the field. The test does not represent all areas of a set of turnout gear. Areas of turnout gear that vary from the basic three-layer composite include pockets, reflective trim, the storm flap, reinforcements, overlaps and clothing worn beneath the turnout gear. The test does not measure heat transfer in compressed areas, such as the areas beneath the Self-Contained Breathing Apparatus (SCBA) shoulder straps. The test does not measure heat transfer in wet gear. Also, the TPP test is a component test (as are most PPE tests) versus an ensemble (system level) test. An improved test might use the entire ensemble (helmets, hoods, turnout garments and pants, gloves, boots and SCBA) on an instrumented manikin capable of movement, especially crawling, and would test the fire environment with temperature fluctuation and forced air movement. As a less complex test, the turnout garment and SCBA system could be tested on a static manikin.

The TPP test is one of the most useful and accepted thermal protection tests. But several other PPE-related tests are required in NFPA 1971. Just for structural coats and trousers, the following “component” tests are performed: Flame Resistance, Thread Melting, Tear Resistance, Seam Strength, Cleaning Shrinkage Resistance, Water Absorption Resistance, Water Penetration Resistance, Liquid Penetration Resistance, Viral Penetration Resistance, Corrosion Resistance, Label Durability, Trim Retro reflectivity, Trim Fluorescence, CCHR (Conductive and Compressive Heat Resistance), Light Degradation Resistance, DRD (Drag Rescue Device) Function, DRD Material Strength, and THL (Total Heat Loss). The Overall Liquid Penetration Test is the only test that involves both the garment and the pants as assembled/donned but does not include a helmet, hood, gloves, boots or SCBA. It is suggested that CNT veil be attached to a protective facecloth veil of Kevlar veil and tested in the TPP and THL test to further characterize the fire-resistant properties of pristine CNT sheet and CNT sheet that is coated with Ceraset.

TPP and THL results from testing CNT fabric with LION Protects fabrics are given in Table 3. Definitions of key variables are: TPP (Thermal Protective Performance), which is the predicted time (in seconds) to a second-degree burn multiplied by the heat exposure (generally 2 cal/cm² sec). Higher TPP means the FF is protected for a longer time before they would receive a second-degree burn. THL (Total Heat Loss) is the heat power per surface area dissipated through the garment. A higher THL means heat stress from metabolic heat will be reduced. Table 3 shows that different combinations of CNT fabric and other standard fabrics can pass the THL and TPP standards. Certain combinations do not pass the standards. Some results in the table are the averages from testing three samples (all data not shown). An example design is number 9 in the table. In the table, the ratio of THLwet/THL dry is computed. The ratio is greater than 2, indicating there is greater heat loss when the garment is wet.

The testing overall shows that decreasing breathability by adding the CNT layer decreases THL. Further design options are to evaluate CNT veil fused to Kevlar veil or facecloth to reduce the thermal resistance of the fabric. CNT veil has small pore sizes, thus it can still filter particles and chemicals and provide limited breathability. Testing also shows that a thin thermal layer passes THL even though the layer can be impermeable to air and water. A thin layer is the main design factor, a thin CNT layer prevents moisture escaping and still allows THL to pass. The CNT veil+Kevlar veil material will filter smoke particles because the pore sizes are smaller than the pores in the Gore-Tex layer.

### Example 2—Fabric Thickness Testing

CNT layer effect. Putting air cooling into the THL or TPP testing was considered. Due to the TPP and THL test set ups, it would be difficult to incorporate air cooling into the THL or TPP testing. Also, the air-cooling unit should be tested with full FF apparel. The TPP and THL tests are material level tests that tell how a composite layered material behaves. Perhaps with the cooling system, different TPP or THL values would be appropriate as the cooling will strongly affect the heat transfer in the garment. Another consideration is the cooling system may not be operational all the time. In this case, the current THL and TTP values might be still appropriate. Placement of the CNT layer in the composite should be considered relative to how it may affect the TPP and THL values. In the TPP test, the fabric composite is placed with the outer shell fabric down facing the flame. The CNT layer placement may affect the result of the test. CNT fabric is a black body that will absorb infrared radiation (heat). Thus, the CNT should be shielded from direct line of site to the flame. The CNT layer will spread heat laterally. Thus, the CNT layer could reduce the hot spot temperature but could increase the overall temperature of the garment if left in contact with the heat source for a long time. In flame testing of CNT fabric, we believe the thermal conductivity of the CNT fabric delays burn through of the fabric by spreading heat away from the flame location. Also, the standard thickness 30-micron CNT layer is impermeable to air and water. Thus, if the CNT layer is placed close to the flame it may reduce convection heat transfer through the sample. This must be determined by testing. The same fabric composition with the CNT layer in distinct locations in the composite should be tested. Also, the compaction of the layers will affect the result. Two options for increasing the repeatability of the TPP testing are given. The first is regarding sensor placement on the fabric. The TPP test may cause the fabric to drape slightly downward which would affect the TPP result. The fabric might be held more securely to prevent draping. The second suggestion is the room temperature, and the temperature of the sensor, could be precisely controlled to reduce slight variations in TPP values.

The total heat loss (THL) test is included in NFPA 1971 to provide a balance between thermal insulation for protection and evaporative cooling insulation for stress reduction. In this test, heat flow through material composites is measured under both dry and wet conditions using a hot plate that simulates skin temperature control. This information is then used to calculate a total heat loss value. Higher THL values are an indication of increased material “breathability,” even though the overall value reflects both conductive and evaporative heat transfer from the body. Testing showed that one type of CNT layer located within the turnout garment decreases the THL value. A recommendation is that a thin veil CNT layer (e.g. using a Kevlar tissue veil) combined with a facecloth may provide limited breathability while increasing protection from toxic chemicals and smoke particles. An additional benefit is the thin CNT veil facecloth may reduce the cost of a CNT layer. Another option is Integrating silicone into the CNT layer which adds strength and toughness to the layer but makes the layer impermeable to air and water. A thin film of silicone in the CNT fabric will also make the fabric easier to cut and manufacture into garments. The silicone will prevent shedding of CNT strands when the fabric is being laser cut or cut using a blade. It is suggested that two configurations of CNT fabric (composite veil and composite with silicone) be tested in the LION Laboratory as future work to determine their suitability for use in turnout garments. Recently, ceraset coated CNT fabric has shown high flame resistance and no significant shedding of CNT strands.

Because the THL will increase with the CNT layer, we use a cooling system inside the garment. The cooling system uses an air circulation method to cool the air. The air circulation cools the firefighter because of convective heat transfer and because of evaporation of moisture. For cooling, the air flow velocity is particularly important inside the garment-it conducts heat away from the body and due to the latent heat of vaporization, it evaporates moisture from the skin and provides cooling. When the CNT shield is used to prevent air and moisture from coming in and out of the garment, and the cooling system is used, heat stress in the firefighter can be reduced independent of the TPP and THL values for the garment fabric.

Once compliance for the intervention CNT fabric was confirmed the team wanted to know how it stood up to the standard material used in the FF garment liners produced by lion. The following chart show the % differences/Change in testing values across the 9 required fabric tests between the intervention garment liner fabric and the Lion garment liner fabric.

### Example 3—Filtering Performance Test

As shown below in Table 4, the thermal apparatus was used to evaluate the filter performance. The smoke pellet can generate 500 Ft3 smoke in one minute after ignition. After igniting the smoke pellet, the box was sealed immediately and the fan was turned on, and the measurement starts. For evaluating the filter performance of chemicals, a gas detector (MultiRAE lite) was used.

Table 4 shows the preliminary data of particle measurement. With the HEPA filter installed, the particle numbers significantly decreased at 1.0 μm, 2.5 μm, 5.0 μm, and 10 μm.

For the filter performance of chemicals, the cooling apparatus is the same, the only difference is the particle counter was replaced with the gas detectors. Volatile organic compounds (VOC) were used as the indicator for the evaluation. The wildfire cartridge (P100, NIOSH certified) was attached to the metal housing and evaluated. Without the wildfire cartridge attached, the VOC was 62 ppm. After attaching the wildfire cartridge, the VOC drops to 40 ppm. The difference is dominant.

The gas detector and particle counters were also used to measure the particle concentration and VOC of the live-burn facility with firefighters' help. The VOC of the smoke from burning wood and straw is (6-8 ppm). The VOC between the garment and the t-shirt was very low (1-2 ppm) for 30% of the live-burn test period. For 70% of the live burn test period, the VOC ppm was too low to detect. The particle concentration of smoke from burning wood and straw; the particle concentration between the garment and the t-shirt is high depending on the firefighter's movement and the smoke condition of the live-burn facility, which is very challenging to measure and analyze. According to the comments of EH&S inquiry and academic research, the VOC should have more concern in our case. After attaching the wildfire cartridge, the filter performance of chemicals was excellent as the VOC dropped significantly (from 8 ppm to 1 ppm).

### Example 4—Air and Water Impermeability Testing and Chemical Penetration Testing on CNT-Ceraset Samples

Tests were conducted on the CNT-Ceraset fabric samples for chemical shielding/penetration. The fabric showed good shielding from water/water-based chemicals due to its hydrophobic characteristics. Oil-based chemicals seem to penetrate the fabric not readily, but over time, because the fabric is oleophilic in nature. More details of the testing are summarized in the sections below.

The chemical penetration test was conducted to observe the penetration of water and chemicals through the CNT-Ceraset under the influence of gravity. A simple setup was devised to study this effect.

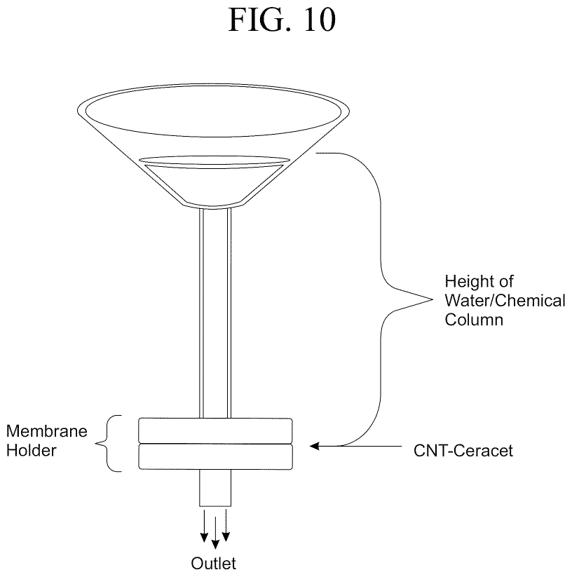

A vertical filtration system was developed using a funnel, tube, and filter holders as represented in FIG. 10, the manufacturing of which is discussed later.

The height of the water/chemical column will generate pressure equal to ρ(density)×g(gravity)×h(height) that forces the water or chemical to go through the CNT-ceraset.

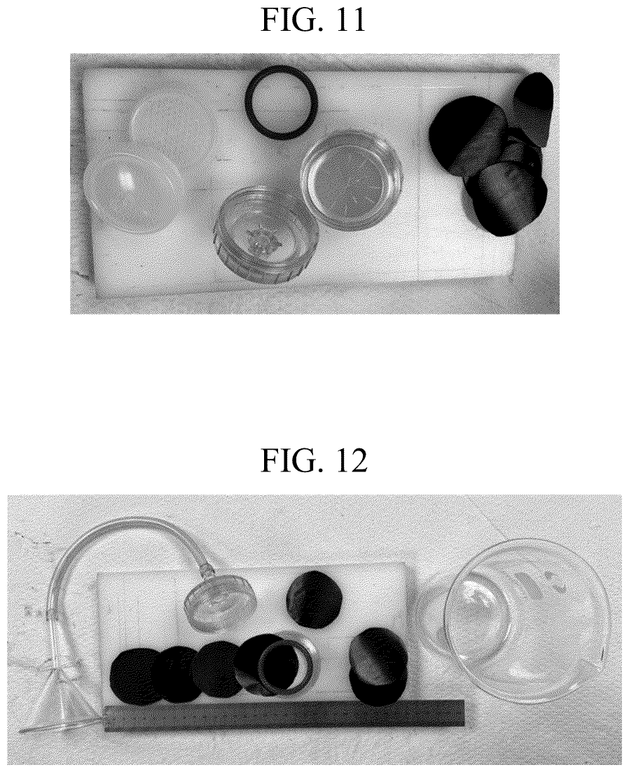

To develop the setup, inline filter holders were purchased from Cole Parmer. CNT-ceraset sheet was cut to prepare samples for the inline filter holder as shown in FIG. 11.

The filters were placed in the filter holder. Gaskets in the filter holder ensured no leakage outside the CNT-ceraset sample. The system was connected to a funnel with the help of a tube as shown in FIG. 12.

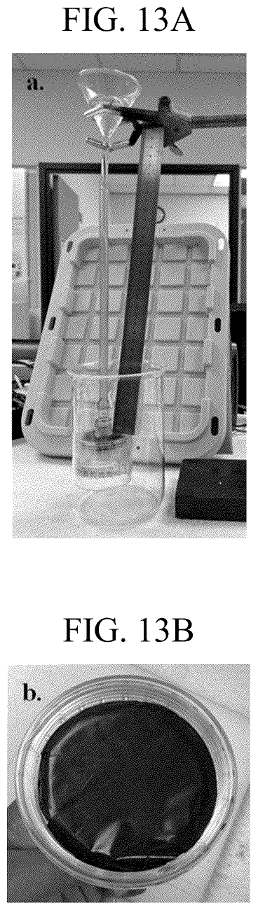

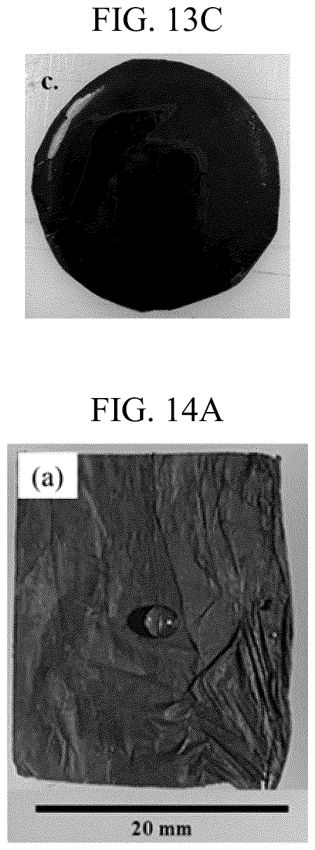

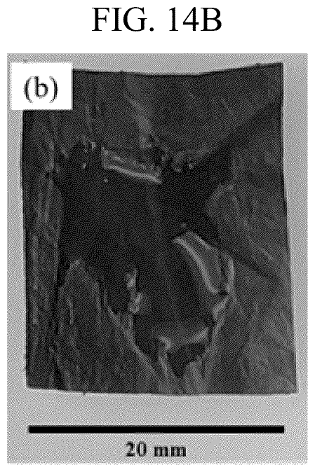

The setup was placed vertically as shown in FIG. 13A.

Water was poured into the funnel. The height of the water level from the filter was ˜35 cm. Therefore, the apparent pressure in the membrane was close to the product of density, acceleration due to gravity and height of the funnel i.e., ˜3430 Pa. The same test was repeated with naphthalene. The pressure in this case was ˜3910 Pa (the density of naphthalene is slightly higher than water).

No penetration of water through the filter holder/CNT-ceraset membrane was observed. After 15 minutes the test was stopped and the back surface of the CNT-ceraset sample was examined. No wetting was observed as shown in FIG. 13B.

On repeating the same test by pouring naphthalene in the funnel, first drop of naphthalene through the filter was observed after 8 minutes. 3 drops were observed in the 15-minute test. On examining the back surface of the CNT-ceraset membrane it was observed that naphthalene penetrated through the CNT-ceraset sheet.

Similar to CNT-sheets, the CNT-ceraset sheets were found to be hydrophobic, but oleophilic. They do not allow the passage of oil-based solvents directly but over time they are wetted by these solvents.

### Example 5—Sweat Manikin Test

The cooling performance of the invention was evaluated by utilizing a sweating manikin at the National Institute for Occupational Safety and Health (NIOSH) (Table 6). This testing involved conducting trials at both ambient temperature (22° C.) and elevated temperature (35° C.) with 20% Relative Humidity. The garment conditions were varied to include both a standard liner commercially available on the market and a CNT (Carbon Nanotube) layup composition with the cooling system installed, but without any coolants inserted. The sweating manikin testing demonstrated the effectiveness of the cooling system to keep CBT below hyperthermic levels in ambient conditions and provided information and how the cold air can be directed in the interior of the garment to optimize cooling. The tests also showed positive results for skin temperature moderation, indicating some level of wicking metabolic heat and sweat, as well as for heat flux, which justifies the CNT.

Table 6 shows that the garment with the CNT liner with the cooling system on with ice in ambient conditions performed most effectively to manage core body temperature with only a 2.212 degree increase in temp from start to finish. The results indicate that the CNT liner with the cooling system activated performs better in ambient conditions compared to the standard LION liner, resulting in a decrease of 3.672 degrees Celsius. The only one test (#1) that kept the core body temperature of the Firefighter below hyperthermic levels throughout the entire test were #1 (below 40° C.), which proves that the garment can keep FFs from reaching the hyperthermic threshold and reduce exposure to. In summary, the NIOSH Mannequin tests justify our design and effectiveness of it for cooling and heat dissipation.

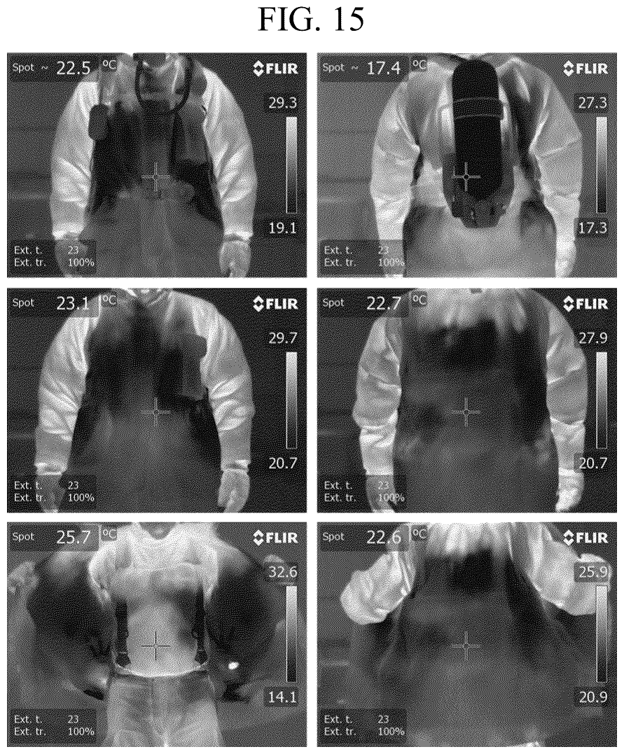

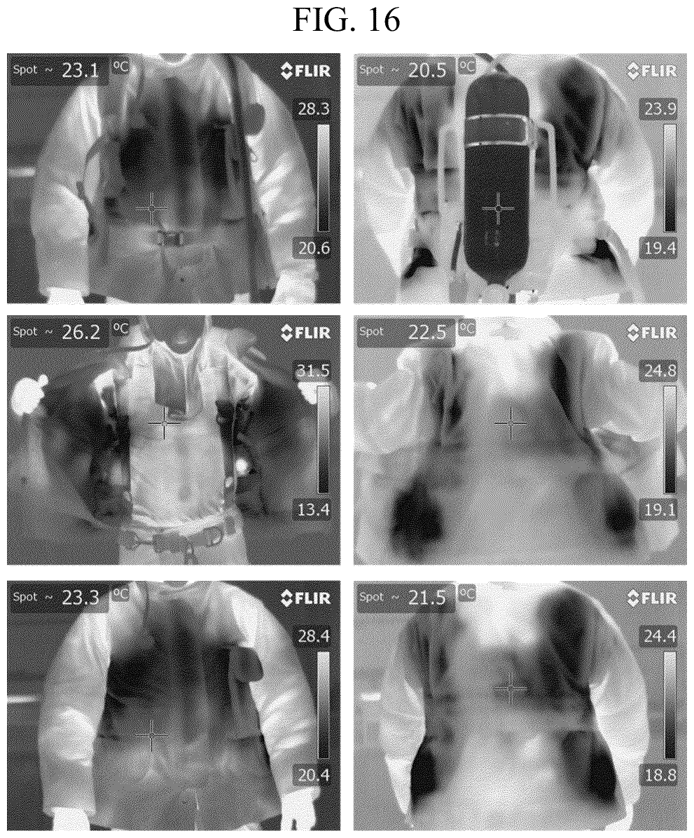

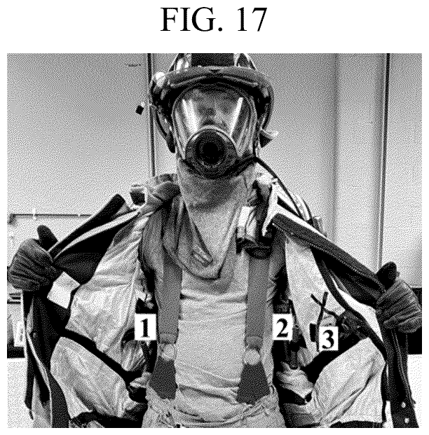

Significant cooling effects were evident from the infrared images of FIGS. 15 and 16. Subjects reported positive experiences regarding both the cooling and comfort provided. In the images, dark purple indicates areas of lower temperature, with significant cooling concentrated around the chest and belly-key regions for reducing core body temperature. Additionally, the images show that the SCBA strap did not obstruct the distribution of cooling air. Cooling was also noticeable inside the coat, where temperatures dropped as low as 14° C. Compared to the external design, the cooling area in the internal design was more concentrated around the upper chest. This is because the cooling device in the internal design was positioned higher than in the external design. Both designs demonstrated excellent cooling effectiveness, as evidenced by the infrared images.

### Example 6—Humidity Test

The invented cooling garment system successfully managed relative humidity levels below 100%, enabling sweat evaporation for effective cooling, unlike conventional systems that reached 100% relative humidity during strenuous activities (Table 7). The relative humidity, expressed as a percentage of water vapor needed for saturation at a specific temperature, is crucial for understanding evaporative cooling. A relative humidity of ˜100% signifies no room for evaporation, leading to the absence of evaporative cooling. Through testing, the proposed garment system effectively maintained relative humidity below 100% in various areas inside the garment, allowing for sweat evaporation and enabling efficient cooling. In contrast, traditional garment systems reached ˜100% relative humidity under the same rigorous exercise conditions. The strategic placement of relative humidity sensors within the firefighter coat, as depicted in the FIG. 17, facilitated these humidity observations.

### Example 7—Lab Test

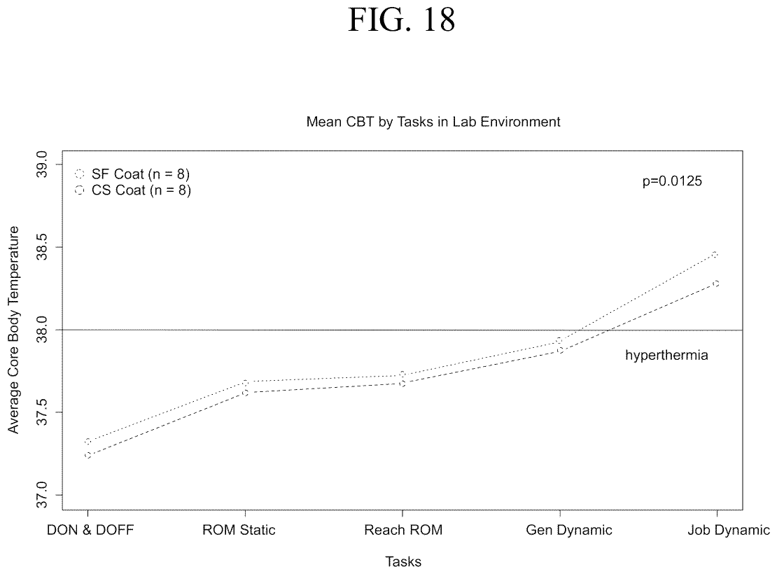

Dr. M. B. Rao provided the analysis of data using the Zephyr Bioharness to measure firefighter biometrics during Lab testing activities conducted in 2022/2023. The comparison was conducted between the Standard Fire (SF) coat that the firefighters already use (e.g. those provided to them by their fire department for duty), and the intervention coats, referred to here as Cool Coats (CS), which include the cooling system and the fabric system integrated into the turnout coat lining. The Standard Fire (SF) and Cool (CS) coats were tested on 8 FFs during live burn training in 2023. The data in FIG. 18 shows that CS coat performance is significantly (p=0.0125) better than SF coat in maintaining acceptable core body temperature (CBT) within the hyperthermia threshold (38 C).

Although not described in detail herein, other steps which are readily interpreted from or incorporated along with the disclosed embodiments shall be included as part of the invention. The embodiments that have been described herein provide specific examples to portray inventive elements, but will not necessarily cover all possible embodiments commonly known to those skilled in the art.

### TABLES

TABLE 1
NFPA 1971 compliance certification tests for new
fabric as a result of including CNT fabric

| | | Control | Year 1 | Year 2 |
|---|---|---|---|---|
| | | without | Pristine | Ceraset |
| Test | Requirement | CNT | CNT | CNT |
| TPP (thermal | No less than 35.0, with layered | 38.6 | 37.95 | 41 |
| protective | composite | | | |
| performance) | | | | |
| THL (Total Heat | No less than 205 W/m², with | 257.3 | 216.85 | 211.28 |
| Loss) | layered composite | | | |
| Conductive + | A determination shall be made if | PASS | 76 | 64 |
| Compressive Heat | time to second degree burn is equal | | | |
| Resistance (CCHR) | to or exceeds 25.0 seconds | | | |
| Tear Resistance Test | No less than 22N (5 lbf) | 110 | 116.8 | 71.67 |
| Cleaning Shrinkage | No more than 5% in any direction | 2 | 1.53 | 1.83 |
| Test | | | | |
| Heat and Thermal | No more than 10% in any direction, | 1 | 0.66 | 0.25 |
| Shrinkage Test | no separation/ignition/melt | | | |
| Flame Resistance | No melt/drip, no more than 2 sec | 0 | 0.49 | 1.16 |
| Test | afterflame, no more than | | | |
| | 4 in/100 mm char length | | | |
| Seam Strength | No less than 334N (75 lbf) | 87.9 | 102.75 | 295.33 |

TABLE 2
Embodiment of the Layered System

| | Material | Description |
|---|---|---|
| 1 | Shell | PBI Max Outershell. 7 oz: 40% PBI/60% Kevlar |
| 2 | Moisture Barrier | Crosstech Black (CROSSTECH membrane laminated to a |
| | | 3.3 oz/yd² NOMEX woven pajamacheck substrate) |
| 3* | E89 Thermal Batting | NOMEX E89 spunlace (1 layer 2.3 oz/yd²) |
| 4* | Ceraset (silicone) treated | |
| | Carbon Nanotube sheet | |
| 5* | Face Cloth | GLIDE 60% NOMEX filament yarn with 40% |
| | | NOMEX/LENZING FR blend spun yarn, twill weave |

*Layers 3, 4 and 5 are stitched together to form the thermal lining

TABLE 3
THL and TPP test results for different fabric combinations

| | | | | | THL | THL | | |
|---|---|---|---|---|---|---|---|---|
| | Outer | Moisture | Thermal | THL | dry | wet | THLwet/ | TPP |
| Case | shell | Barrier | Liner | (Average) | (W/m\hat{ }2) | (W/m\hat{ }2) | THLdry | (Average) |
| 1 | 6.0 | Crosstech | UC | 175.89 | 47.52 | 129.37 | 2.72 | 42.4 |
| | PBI | Black | thermal | W/m² | | | | cal/cm² |
| | Max | | liner | | | | | |
| | | | (Glide | | | | | |
| | | | Facecloth | | | | | |
| | | | sewn to | | | | | |
| | | | Araflo | | | | | |
| | | | Quilt | | | | | |
| | | | 2.3/1.5) | | | | | |
| | | | with CNT | | | | | |
| | | | sheet | | | | | |
| 2 | 6.0 | Crosstech | CNT sheet | 284.66 | 105.26 | 179.4 | 1.70 | 24.6 |
| | PBI | Black | with Glide | W/m² | | | | cal/cm² |
| | Max | | Ice | | | | | |
| | | | Facecloth | | | | | |
| 3 | 6.0 | Crosstech | Carbon | 280.2 | 88.26 | 191.94 | 2.17 | |
| | PBI | Black | Veil with | W/m² | | | | |
| | Max | | Glide Ice | | | | | |
| | | | Facecloth | | | | | |
| 4 | 6.0 | Crosstech | UC | 82.95 | 46.17 | 136.78 | 2.96 | |
| | PBI | Black | thermal | W/m² | | | | |
| | Max | | Liner | | | | | |
| | | | (Glide Ice | | | | | |
| | | | Facecloth | | | | | |
| | | | sewn to | | | | | |
| | | | Araflo | | | | | |
| | | | Quilt | | | | | |
| | | | 2.3/1.5) | | | | | |
| | | | with CNT | | | | | |
| | | | Perforated | | | | | |
| | | | ¼″ | | | | | |
| | | | spacing | | | | | |
| 5 | 6.0 | Crosstech | UC | 88.45 | 52.19 | 136.26 | 2.61 | |
| | PBI | Black | thermal | W/m² | | | | |
| | Max | | liner | | | | | |
| | | | (Glide Ice | | | | | |
| | | | Facecloth | | | | | |
| | | | sewn to | | | | | |
| | | | Araflo | | | | | |
| | | | Quilt | | | | | |
| | | | 2.3/1.5) | | | | | |
| | | | with CNT | | | | | |
| | | | perforated | | | | | |
| | | | ⅛″ | | | | | |
| | | | spacing | | | | | |
| 6 | 6.0 | Crosstech | CNT with | 215.54 | 53.27 | 162.27 | 3.05 | 35.75 |
| | PBI | Black | Glide 1 L | W/m² | | | | cal/cm² |
| | Max | | Araflo | | | | | |
| 7 | 6.0 | Crosstech | CNT with | 221.03 | 62.73 | 158.30 | 2.52 | 34.775 |
| | PBI | Black | Glide 1 L | W/m² | | | | cal/cm² |
| | Max | | E89 | | | | | |
| 8 | 6.0 | Crosstech | LION | 257.3 | 84.62 | 172.48 | 2.04 | 38.6 |
| | PBI | Black | Express | W/m² | | | | cal/cm² |
| | Max | | Lining: | | | | | |
| 9 | 7.0 | Crosstech | Glide 1 L | 216.85 | 68.73 | 148.13 | 2.16 | 38.45 |
| | PBI | Black | E89 | | | | | |
| | Max | | w/CNT 1- | | | | | |
| | | | 10-2023 | | | | | |
| 10 | 7.0 | Crosstech | CNT then | 226.89 | 72.36 | 154.55 | 2.14 | 37.45 |
| | PBI | Black | Glide 1 L | | | | | |
| | Max | | E89 1-12- | | | | | |
| | | | 2023 | | | | | |

| | | |
|---|---|---|
| Control- no less than the | 205 | 35.0 |
| following values | W/m² | cal/cm² |

TABLE 4
Particle data of the HEPA filter

| | Smoke without filtration | Smoke after filtration |
|---|---|---|
| Particle Size | (particles/L) | (particles/L) |
| 0.3 μm | Above 105900 | Around 26618 |
| 0.5 μm | Above 91400 | Around 25448 |
| 0.7 μm | Above 83500 | Around 23800 |
| 1.0 μm | Above 74690 | Around 22269 |
| 2.5 μm | Above 40418 | Around 18026 |
| 5.0 μm | Above 22881 | Around 14839 |
| 10 μm | Above 16107 | Around 12623 |

TABLE 5
The comparison of the VOC inside the
coat with/without chemical cartridge

| | Without cartridge | With cartridge |
|---|---|---|
| Inside the coat (VOC) | ~8 ppm | <2 ppm |

TABLE 6
Core Body Temperature (CBT) Moderation performance
under various Testing Conditions Unit: ° C.

| | Environment Conditions | | | | | |
|---|---|---|---|---|---|---|
| | Ambient (22° C.), 20% Relative Humidity | | | Heated (35° C.), 20% Relative Humidity | | |
| | Test | | | | | |
| | #1 | #2 | #3 | #4 | | |
| | Garment Conditions | | | | | |
| | CNT Liner | CNT Liner | | CNT Liner | CNT Liner | |
| | Cooling | Cooling | Lion | Cooling | Cooling | Lion |
| | System On | System On | Standard | System On | System On | Standard |
| | with ICE | with No ICE | Liner | with ICE | with no ICE | Liner |
| Starting CBT | 36.722 | 36.682 | 36.648 | 36.653 | 37.009 | 36.7 |
| Ending CBT | 38.934 | 39.749 | 40.318 | 40.649 | 40.146 | 41.28 |
| Temperature | 2.212 | 3.067 | 3.672 | 3.996 | 3.137 | 4.58 |
| Difference | | | | | | |

TABLE 7
Relative Humidity data at different locations inside firefighter's coat

| | Garment | Sensor 1 (RH %) | | | Sensor 2 (RH %) | | | Sensor 3 (RH %) | | |
|---|---|---|---|---|---|---|---|---|---|---|
| Date | Type | Max. | Min. | Avg. | Max. | Min. | Avg. | Max. | Min. | Avg. |
| 2024 Apr. 4 | External | 96.1 | 53.2 | 87.0 | 95.4 | 50.5 | 85.6 | 100 | 49.7 | 84.3 |
| 2024 Apr. 11 | External | 93 | 56.7 | 79.5 | 94.1 | 47.8 | 80.5 | 100 | 44.5 | 78.2 |
| 2024 Apr. 15 | External | 92.7 | 45.2 | 72.2 | 90.7 | 46.4 | 81.3 | 100 | 47 | 79.4 |
| 2024 Apr. 18 | External | 95.9 | 43.2 | 76.6 | 93.5 | 43.8 | 76.5 | 100 | 43.4 | 71.6 |
| 2024 Apr. 22 | External | 97.6 | 25 | 59.2 | 91.4 | 24.5 | 53.3 | 86.0 | 24.9 | 43.0 |
| 2024 Apr. 23 | External | 98.8 | 26.7 | 65.0 | 84.2 | 22.2 | 50.5 | 81.0 | 26.2 | 48.6 |
| 2024 Apr. 25 | Internal | 94.7 | 29.4 | 73 | 93.2 | 28.1 | 69.5 | 99.3 | 27.2 | 64.2 |
| 2024 Apr. 29 | Internal | 97.4 | 52.7 | 78.7 | 90.3 | 53.1 | 76.4 | 99.4 | 47.7 | 80.1 |
| 2024 Apr. 30 | Internal | 98.0 | 55.7 | 84.5 | 88.7 | 54.5 | 77.7 | 99.7 | 49.0 | 80.1 |
| | (Incomplete) | | | | | | | | | |
| 2024 May 1 | External | 97.7 | 50.9 | 79.1 | 90.5 | 50.8 | 77.6 | 99.2 | 52.9 | 75.6 |
| 2024 May 2 | Internal | 98.4 | 44.3 | 78.6 | 93.0 | 53.2 | 72.4 | 100 | 54.2 | 78.5 |
| 2024 May 6 | Internal | 98.1 | 52.6 | 89.0 | 92.8 | 56.6 | 83.1 | 100 | 48.5 | 85.4 |
| | (Small | | | | | | | | | |
| | SCBA tank) | | | | | | | | | |
| 2024 May 9 | Internal | 99.0 | 48.0 | 80.6 | 95.0 | 45.7 | 70.1 | 99.8 | 47.5 | 81.4 |

What is claimed is:

1. A wearable garment capable of providing protection from heat wherein the garment comprises a fabric layer comprising a carbon nanotube (CNT) sheet.

2. The wearable garment of claim 1, wherein the fabric layer further comprises a layer of meta-aramid material.

3. The wearable garment of claim 1, wherein the CNT sheet is integrated with a meta-aramid material by stitching the CNT sheet and meta-aramid material together, wherein the meta-aramid material is Nomex fabric.

4. The wearable garment of claim 2, wherein the fabric layer further comprises a layer of woven thermal facecloth fabric.

5. The wearable garment of claim 1, wherein the carbon nanotube sheet is produced using a floating catalyst Chemical Vapor Deposition (CVD) method.

6. The wearable garment of claim 5, wherein the carbon nanotube sheet is made by dry drawing of CNT arrays produced by a CVD method.

7. The wearable garment of claim 5, wherein the carbon nanotube sheet comprises Bucky Paper produced by dispersing carbon nanotubes in solution followed by their filtration.

8. The wearable garment of claim 1, wherein the carbon nanotube sheet is coated with a protective polymer film for enabling ease of handling and reduced shedding during washing.

9. The wearable garment of claim 8, wherein the carbon nanotube sheet is coated with a material comprising polyureasilazane.

10. The wearable garment of claim 1, further comprising a core guard, wherein the core guard is attached as an additional and detachable panel that is mounted to the garment to accommodate and hold a cooling apparatus for a user.

11. The wearable garment of claim 10, wherein a gap is created in the core guard that allows forced cool air flow through the garment.

12. The wearable garment of claim 11, wherein air circulates internally between the garment and a user's undergarment and air circulation is driven by two incorporated cooling devices.

13. The wearable garment of claim 10, wherein the core guard has a design that supports internal cooling and is located at an elevated level within the garment thus preventing air from being sucked from the outside environment and penetrating the garment.

14. The wearable garment of claim 12, wherein the garment is configured so air is supplied from the outside environment drawn by a cooling device and circulates between the garment and a user's undergarment, then leaving the garment through any openings, including sleeves, collar, and lower portion of the garment.

15. The wearable garment of claim 10, wherein the core guard has a design that supports external cooling and is located at a lower level within the garment thus enabling air to be sucked from the outside environment and penetrating the garment.

16. The wearable garment of claim 12, wherein a fabric-made pouch is sewn onto the core guard.

17. The wearable garment of claim 16, wherein the pouch has a mesh at its bottom part allowing air to be drawn in a cooling device.

18. The wearable garment of claim 17, wherein the pouch accommodates a coolant material selected from the group consisting of dry ice, water-based ice, and other packed coolants.

19. The wearable garment of claim 18, further comprising a water repelling ISO Dry Knit to protect electric wire connections from water and sweat.

20. The wearable garment of claim 1, comprising a cooling unit made from fire resistant materials that pass the standard tests for National Fire Protection Agency compliance.
